(19) United States
(12) Patent Application Publication
(10) Pub. No.: US 2024/0089388 A1
(43) Pub. Date: Mar. 14, 2024

(54) ELECTRONIC APPARATUS AND NON-TRANSITORY COMPUTER READABLE MEDIUM

(71) Applicant: FUJIFILM BUSINESS INNOVATION CORP., Tokyo (JP)

(72) Inventor: Takaki SAIKI, Kanagawa (JP)

(73) Assignee: FUJIFILM BUSINESS INNOVATION CORP., Tokyo (JP)

(21) Appl. No.: 18/187,948

(22) Filed: Mar. 22, 2023

(30) Foreign Application Priority Data
Sep. 14, 2022 (JP) 2022-146418

(51) Int. Cl. H04N 1/00; G06V 10/25; G06V 40/10

(52) U.S. Cl. CPC H04N 1/00896; G06V 10/25; G06V 40/10; G06V 2201/07

(57) ABSTRACT

An electronic apparatus includes a human detector configured to detect presence of an observation target and a processor, and a detection area of the human detector includes a first detection area, a second detection area located farther from the human detector than the first detection area is, and a third detection area that includes the second detection area and a region located farther from the human detector than the second detection area is. The processor is configured to: transition the electronic apparatus from a first power-consumption mode to a second power-consumption mode when an observation target is detected in the third detection area, power consumption being larger in the second power-consumption mode than in the first power-consumption mode; transition the electronic apparatus to a third power-consumption mode when the observation target is detected in the first detection area, the power consumption being larger in the third power-consumption mode than in the second power-consumption mode; and transition the electronic apparatus to a fourth power-consumption mode when the observation target is no longer detected in the first detection area or in the second detection area after the electronic apparatus enters the third power-consumption mode, the power consumption being smaller in the fourth power-consumption mode than in the third power-consumption mode.

### CROSS-REFERENCE TO RELATED APPLICATIONS

This application is based on and claims priority under 35 USC 119 from Japanese Patent Application No. 2022-146418 filed Sep. 14, 2022.

### BACKGROUND

### (i) Technical Field

The present disclosure relates to an electronic apparatus and a non-transitory computer readable medium.

### (ii) Related Art

Japanese Patent No. 5348295 proposes a technology in which a mobile object present around an apparatus is detected separately in multiple detection areas located at different distances from the apparatus and the apparatus is caused to exit the power-saving mode of power consumption and is restored to the normal mode in a stepwise manner. In Japanese Patent No. 5348295, when a mobile object is detected in the detection area closest to the apparatus, the apparatus is restored to the normal mode to avoid an improper return to the normal mode due to the detection of a passer-by who does not use the apparatus.

Japanese Patent No. 5790854 proposes a technology in which the transition to the power-saving mode occurs when a mobile object is no longer detected in the detection area for performing control of restoring the normal mode after the mobile object is detected in the detection area in such a technology as proposed in Japanese Patent No. 5348295.

### SUMMARY

An electronic apparatus equipped with a human detector is controlled, for example, for saving energy so as to transition from the power-saving mode to the normal operating mode when an observation target enters the detection area of the human detector and transition from the normal operating mode to the power-saving mode when the observation target exits the detection area.

However, if switching between the power-saving mode and the normal operating mode is controlled based on a single detection area, the point of transition from the power-saving mode to the normal operating mode and the point of transition from the normal operating mode to the power-saving mode cannot independently be set.

Aspects of non-limiting embodiments of the present disclosure relate to providing an electronic apparatus and a non-transitory computer readable medium that are able to independently set the point of transition from the power-saving mode to the normal operating mode and the point of transition from the normal operating mode to the power-saving mode.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electronic apparatus including: a human detector configured to detect presence of an observation target; and a processor, wherein a detection area of the human detector includes a first detection area, a second detection area located farther from the human detector than the first detection area is, and a third detection area that includes the second detection area and a region located farther from the human detector than the second detection area is, and wherein the processor is configured to: transition the electronic apparatus from a first power-consumption mode to a second power-consumption mode when an observation target is detected in the third detection area, power consumption being larger in the second power-consumption mode than in the first power-consumption mode; transition the electronic apparatus to a third power-consumption mode when the observation target is detected in the first detection area, the power consumption being larger in the third power-consumption mode than in the second power-consumption mode; and transition the electronic apparatus to a fourth power-consumption mode when the observation target is no longer detected in the first detection area or in the second detection area after the electronic apparatus enters the third power-consumption mode, the power consumption being smaller in the fourth power-consumption mode than in the third power-consumption mode.

### BRIEF DESCRIPTION OF THE DRAWINGS

An exemplary embodiment of the present disclosure will be described in detail based on the following figures, wherein:

FIG. 1 is an external view for illustrating a schematic configuration of an image forming apparatus according to the exemplary embodiment;

FIG. 2 is a block diagram depicting a hardware configuration of the image forming apparatus;

FIG. 3 is a block diagram depicting a functional configuration of the image forming apparatus;

FIG. 4 is a drawing for illustrating the detection area of a human detector and depicts the first state in the table in FIG. 6 described below;

FIG. 5 is a graph depicting an example of a signal detected by an ultrasonic sensor, which is a human detector;

FIG. 6 is a table depicting a relationship between the detected or undetected states in the detection areas of the image forming apparatus and the power-consumption modes of the image forming apparatus according to the present exemplary embodiment;

FIG. 7 is a drawing depicting the second state in the table in FIG. 6;

FIG. 8 is a drawing depicting the third state in the table in FIG. 6;

FIG. 9 is a drawing depicting the fourth state in the table in FIG. 6;

FIG. 10 is a drawing depicting the fifth state in the table in FIG. 6;

FIG. 11 is a drawing depicting a situation in which two observation targets are present in the detection area of the human detector and in which the two observation targets are located one each in the first detection area and the second detection area;

FIG. 12 is a drawing depicting a situation in which two observation targets are present in the detection area of the human detector and in which one of the two observation targets is located outside the second detection area;

FIG. 13 is a drawing depicting a situation in which the size of the second detection area of the human detector of the image forming apparatus according to the present exemplary embodiment is changed;

FIG. 14 is a flowchart for describing a process for controlling the power-consumption mode performed by the image forming apparatus according to the present exemplary embodiment; and

FIG. 15 is a drawing for illustrating the detection area of a human detector of an image forming apparatus according to a modification to the present exemplary embodiment.

### DETAILED DESCRIPTION

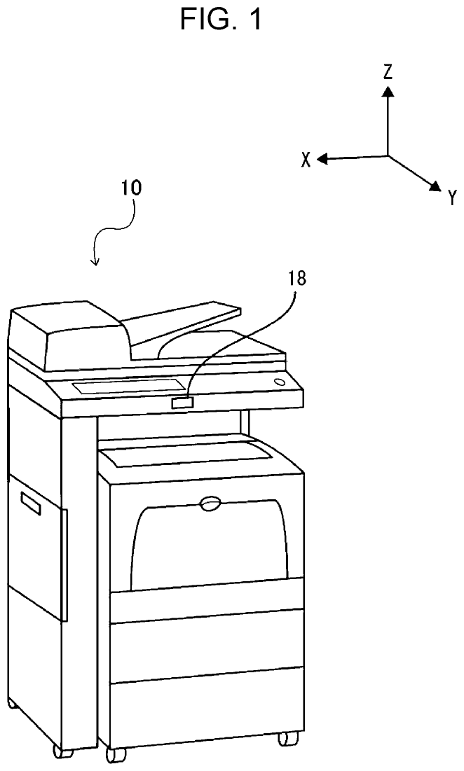

An exemplary embodiment of the present disclosure will be described in detail hereinafter with reference to the drawings. FIG. 1 is an external view for illustrating a schematic configuration of an image forming apparatus 10 according to the exemplary embodiment. The X-axis, Y-axis, and Z-axis in FIG. 1 represent coordinate axes of the image forming apparatus 10. The X-axis direction is horizontal and represents the width direction of the apparatus, the Y-axis direction is horizontal and represents the depth direction of the apparatus, and the Z-axis direction is vertical and represents the height direction of the apparatus.

As depicted in FIG. 1, the image forming apparatus 10 has multiple functions such as a print function, a scan function, a copying function, and a facsimile function and is called a multifunction peripheral. The image forming apparatus 10 is an example of an electronic apparatus in the technology of the present disclosure.

The image forming apparatus 10 includes a human detector 18 configured to detect a user who uses the image forming apparatus 10. Since a user usually moves toward the position where the image forming apparatus 10 is placed, the human detector 18 is set to detect such a user.

For example, the operating mode of the image forming apparatus 10 according to the present exemplary embodiment is controlled so that the image forming apparatus 10 is caused to exit the power-saving mode and is restored to the normal operating mode by using the human detector 18 to detect a user who uses the image forming apparatus 10.

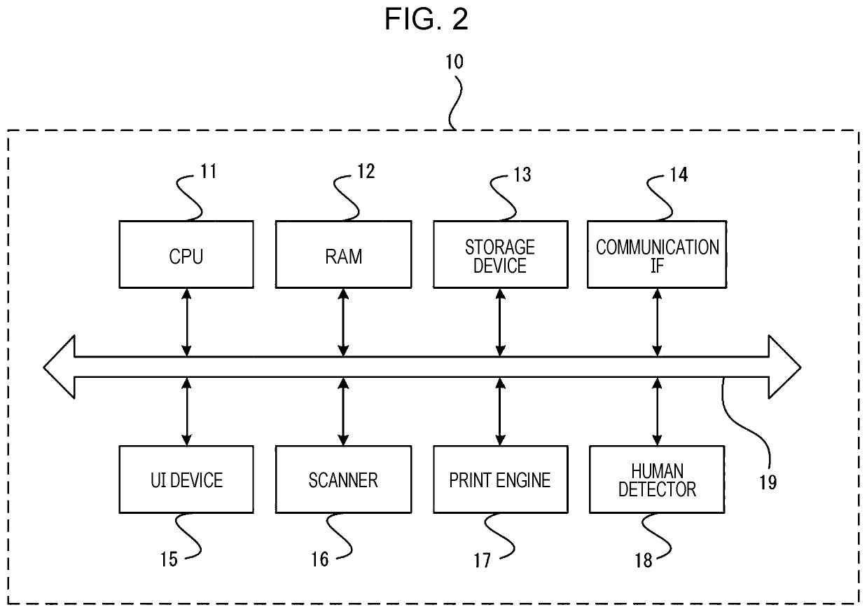

Next, a hardware configuration of the image forming apparatus 10 according to the present exemplary embodiment will be described. FIG. 2 is a block diagram depicting the hardware configuration of the image forming apparatus 10.

As depicted in FIG. 2, the image forming apparatus 10 includes a central processing unit (CPU) 11, a random-access memory (RAM) 12, a storage device 13 such as a hard disk drive, a communication interface (abbreviated to IF) 14, a user interface (abbreviated to UI) device 15 including a touch panel or a liquid crystal display and a keyboard, a scanner 16, a print engine 17, and the human detector 18. These components are connected to each other by using a control bus 19.

The CPU 11 is a processor that is configured to perform predetermined processing in accordance with a control program stored in the RAM 12 or in the storage device 13 and that is configured to control operation of the image forming apparatus 10. Although the description in the present exemplary embodiment will be given on the assumption that the CPU 11 is configured to read and execute the control program stored in the RAM 12 or in the storage device 13, the description will be given by way of illustration and not by way of limitation. The control program may be recorded in a computer-readable recording medium and provided in the form of the computer-readable recording medium. For example, the program may be stored in an optical disc, such as a compact disc read-only memory (CD-ROM) and a digital versatile disc read-only memory (DVD-ROM), or a semiconductor memory, such as a universal serial bus (USB) memory and a memory card, and such a recording medium may be provided. Further, the control program may be acquired from an external apparatus via a communication line connected to the communication IF 14.

The communication IF 14 is configured to transmit and receive data to and from, for example, an external apparatus. The UI device 15 is configured to receive an instruction entry from a user. The scanner 16 is configured to read as image data a document placed on the image forming apparatus 10. The print engine 17 is configured to print an image on a recording medium such as a sheet of printing paper after performing processes such as charging, exposure, development, transfer, and fixing.

Any type of sensor can be adopted as the human detector 18 as long as the presence of an observation target can be detected, and examples of such a sensor include an ultrasonic sensor and a pyroelectric sensor. An example of using an ultrasonic sensor will be described in the present exemplary embodiment.

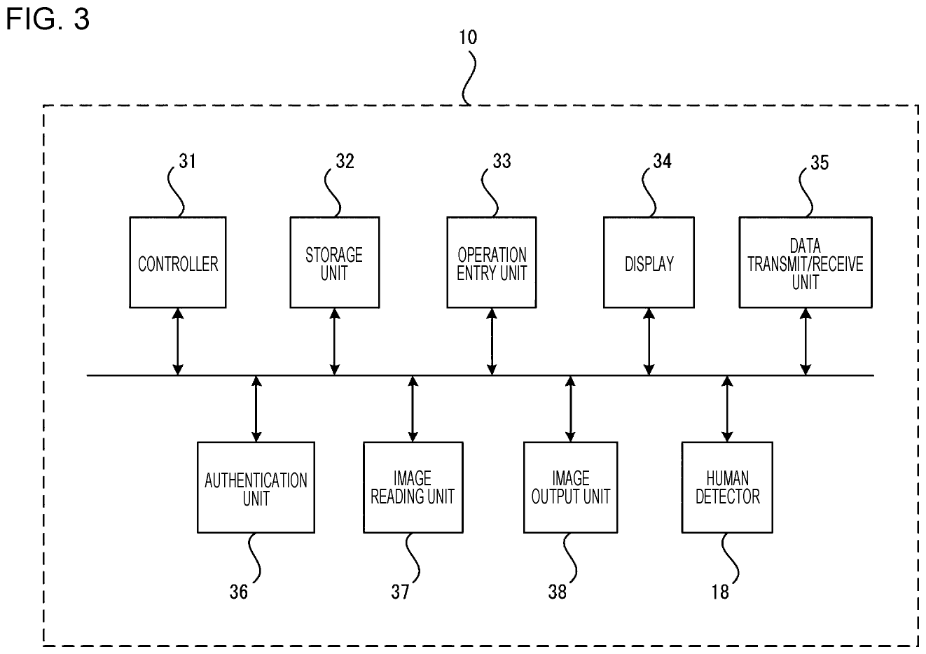

Next, a functional configuration of the image forming apparatus 10 according to the present exemplary embodiment will be described. FIG. 3 is a block diagram depicting the functional configuration of the image forming apparatus 10.

As depicted in FIG. 3, the image forming apparatus 10 according to the present exemplary embodiment includes a controller 31, a storage unit 32, an operation entry unit 33, a display 34, a data transmit/receive unit 35, an authentication unit 36, an image reading unit 37, an image output unit 38, and the human detector 18.

The controller 31 is configured to control overall operation of the image forming apparatus 10, and examples of such control include causing the image reading unit 37 to read a document image and causing the image output unit 38 to output print data in accordance with an instruction entry from the user. Examples of the control by the controller 31 also include detecting an observation target by using a signal detected by the human detector 18. The storage unit 32 is configured to store data such as the control program.

The operation entry unit 33 is configured to receive information regarding various operations performed by the user. The display 34 is controlled by the controller 31 and is configured to display various kinds of information to the user. The data transmit/receive unit 35 is configured to transmit and receive data to and from an external apparatus. The authentication unit 36 is configured to perform an authentication process for a user who is going to use the image forming apparatus 10.

The image reading unit 37 is configured to read a document image from a placed document in accordance with the control by the controller 31. The image output unit 38 is configured to output an image on a recording medium such as a sheet of printing paper in accordance with the control by the controller 31.

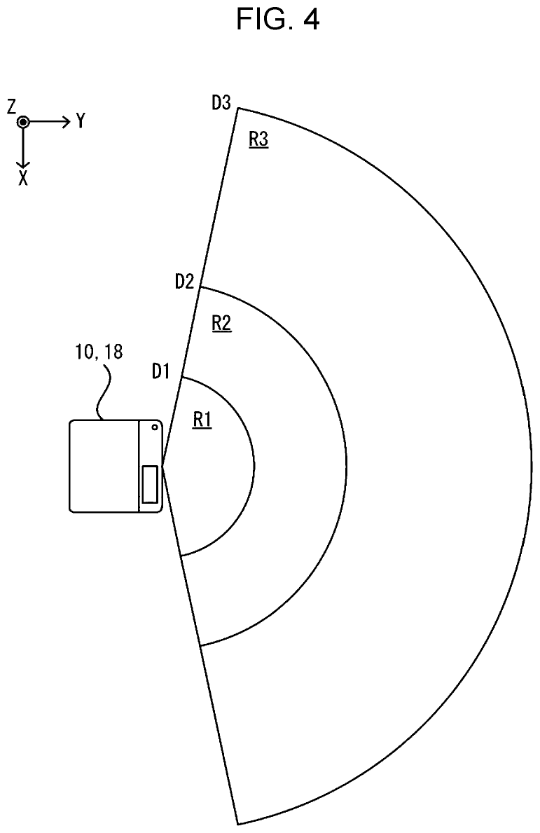

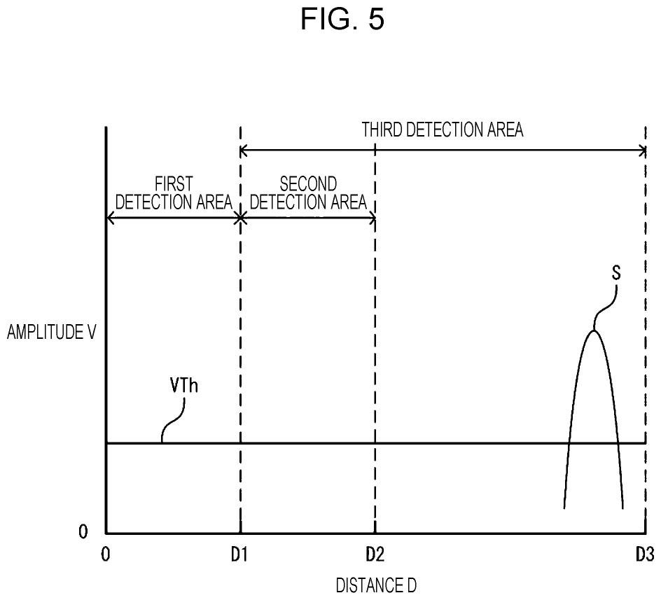

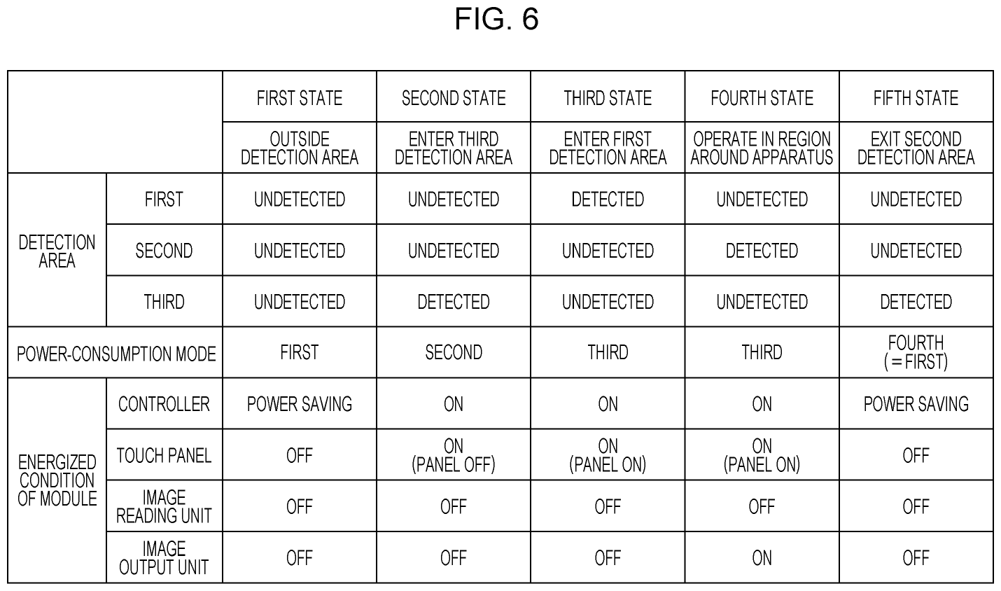

Next, a detailed description will be given with regard to the detection of an observation target by the human detector 18 included in the image forming apparatus 10. FIG. 4 is a drawing for illustrating the detection area of the human detector 18 according to the present exemplary embodiment and depicts the first state in the table in FIG. 6 described below. FIG. 5 is a graph depicting an example of a signal detected by an ultrasonic sensor, which is the human detector 18.

As depicted in FIG. 4, the detection area of the human detector 18 includes the first detection area R1, the second detection area R2 located farther from the human detector 18 than the first detection area R1 is, and the third detection area R3 that includes the second detection area R2 and a region located farther from the human detector 18 than the second detection area R2 is.

The first detection area R1 is located within the distance D1 from the human detector 18 in the detection area of the human detector 18. In addition, the second detection area R2 is located farther than the distance D1 and within the distance D2 in the detection area of the human detector 18. Further, the third detection area R3 is located farther than the distance D1 and within the distance D3 in the detection area of the human detector 18.

As depicted in FIG. 5, a signal detected by the ultrasonic sensor, which is the human detector 18 in the present exemplary embodiment, is represented as a pulsed signal S in a graph having a distance D (m) from the human detector 18 as the horizontal axis and the amplitude V (V) of the voltage as the vertical axis.

The controller 31 is configured to recognize that an observation target is detected in a detection area when a signal S having an amplitude equal to a predetermined threshold VTh or larger is detected in the detection area in this graph.

The controller 31 is configured to transition the image forming apparatus 10 from the first power-consumption mode to the second power-consumption mode when the observation target is detected in the third detection area R3, power consumption being larger in the second power-consumption mode than in the first power-consumption mode, transition the image forming apparatus 10 to the third power-consumption mode when the observation target is detected in the first detection area R1, power consumption being larger in the third power-consumption mode than in the second power-consumption mode, and transition the image forming apparatus 10 to the fourth power-consumption mode when the observation target is no longer detected in the first detection area R1 or in the second detection area R2 after the image forming apparatus 10 enters the third power-consumption mode, power consumption being smaller in the fourth power-consumption mode than in the third power-consumption mode.

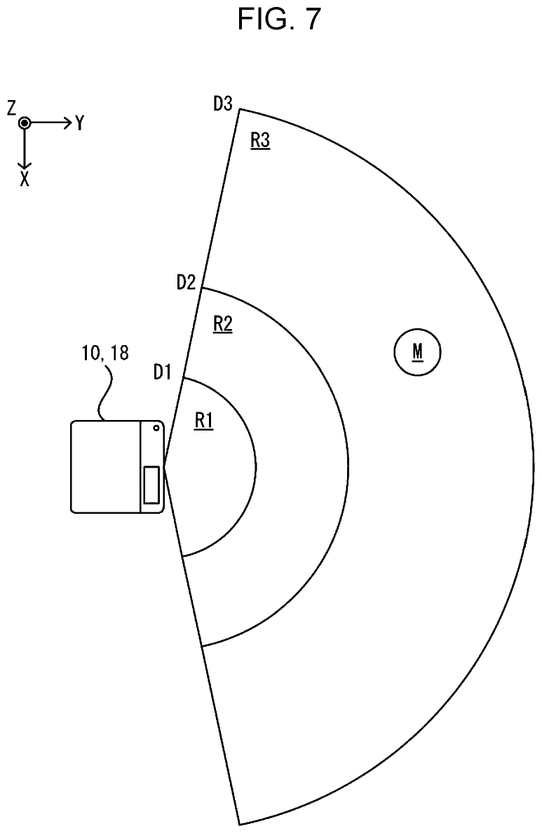

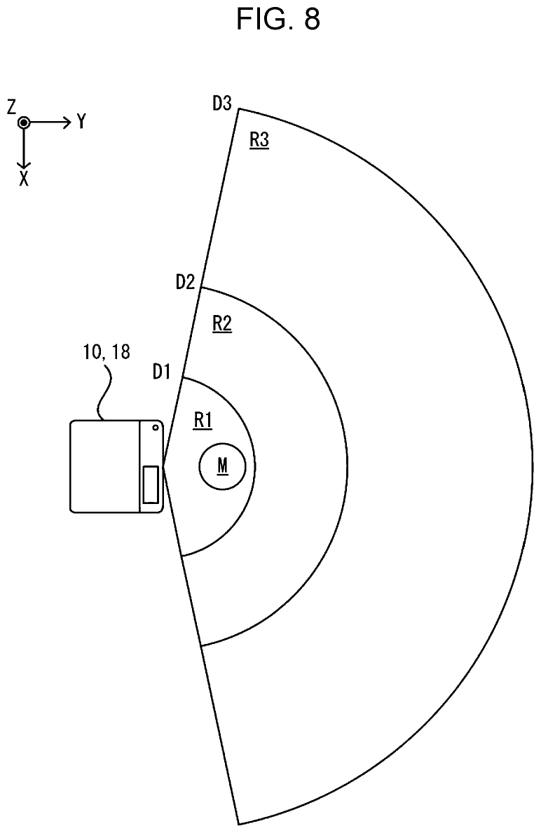

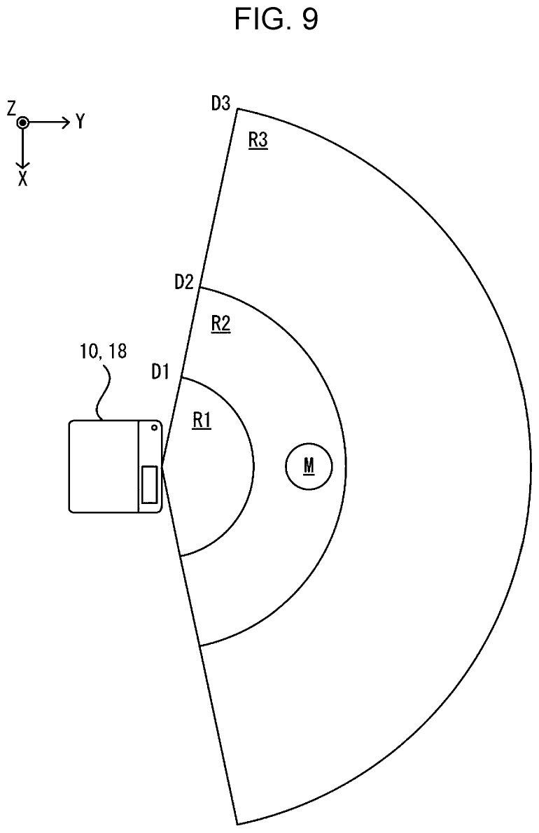

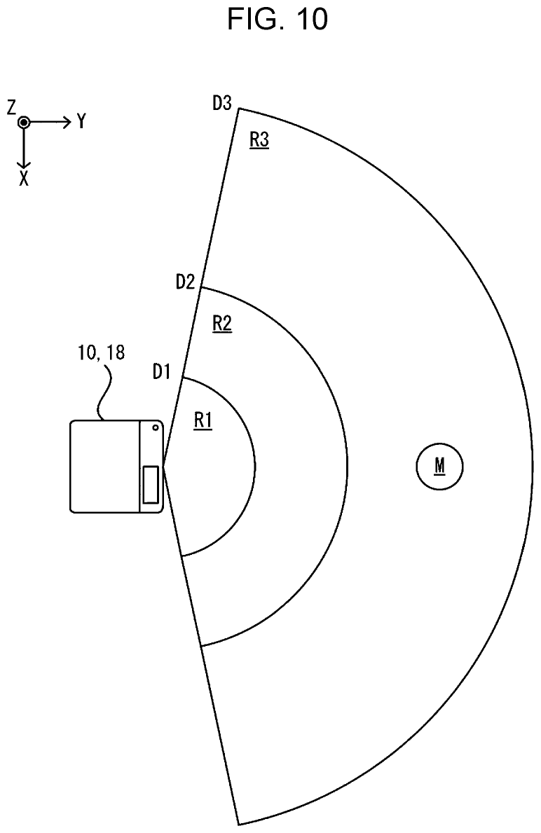

A detailed description will be given herein with regard to the control of the power-consumption mode of the image forming apparatus 10 by the controller 31. FIG. 6 is a table depicting a relationship between the detected or undetected states in the detection areas of the image forming apparatus 10 and the power-consumption modes of the image forming apparatus 10 according to the present exemplary embodiment. FIG. 7 is a drawing depicting the second state in the table in FIG. 6. FIG. 8 is a drawing depicting the third state in the table in FIG. 6. FIG. 9 is a drawing depicting the fourth state in the table in FIG. 6. FIG. 10 is a drawing depicting the fifth state in the table in FIG. 6.

First, as depicted in FIG. 4 and in the first state in the table in FIG. 6, when no observation target M is present in the detection area of the human detector 18, the controller 31 sets the power-consumption mode of the image forming apparatus 10 to the first power-consumption mode in which power consumption is minimum.

The controller 31 is able to change the power-consumption mode of the image forming apparatus 10 in a stepwise manner by changing energized conditions of the controller 31, the touch panel, the image reading unit 37, and the image output unit 38. The touch panel is a device configured to serve as the operation entry unit 33 and the display 34.

For example, the first power-consumption mode is the power-saving mode in which the controller 31 is in a power-saving mode, the touch panel is switched off, the image reading unit 37 is switched off, and the image output unit 38 is switched off.

Next, as depicted in FIG. 7 and in the second state in the table in FIG. 6, when an observation target M is detected in the third detection area R3 in the detection area of the human detector 18, the controller 31 transitions the image forming apparatus 10 from the first power-consumption mode to the second power-consumption mode in which power consumption is larger than in the first power-consumption mode.

For example, the second power-consumption mode is the partial start-up mode in which the controller 31 is switched on, the touch panel is switched on, the image reading unit 37 is switched off, and the image output unit 38 is switched off. The touch panel is switched on, but the panel is switched off in the partial start-up mode.

Next, as depicted in FIG. 8 and in the third state in the table in FIG. 6, when the observation target M is detected in the first detection area R1 in the detection area of the human detector 18, the controller 31 transitions the image forming apparatus 10 to the third power-consumption mode in which power consumption is larger than in the second power-consumption mode.

For example, the third power-consumption mode is the normal operating mode in which the controller 31 is switched on, the touch panel is switched on, the image reading unit 37 is switched off, and the image output unit 38 is switched off.

The touch panel is switched on, and the panel is switched on in the normal operating mode. Although the image reading unit 37 and the image output unit 38 are both usually switched off, only the image reading unit 37 may be switched on, only the image output unit 38 may be switched on, or both of the image reading unit 37 and the image output unit 38 may be switched on in accordance with a job to be performed by the image forming apparatus 10.

Next, as depicted in FIG. 9 and in the fourth state in the table in FIG. 6, when the observation target M is present in the first detection area R1 or in the second detection area R2, that is, when the user seems operating in the region around the image forming apparatus 10, the controller 31 maintains the third power-consumption mode.

The fourth state in the table in FIG. 6 indicates a situation in which the observation target M is detected in the second detection area R2. The fourth state in the table in FIG. 6 indicates an example of a situation in which a copying job is performed by the image forming apparatus 10 and only the image output unit 38 is switched on.

Finally, as depicted in FIG. 10 and in the fifth state in the table in FIG. 6, when the observation target M is no longer detected in the first detection area R1 or in the second detection area R2 after the image forming apparatus 10 enters the third power-consumption mode, that is, when the user exits the region around the image forming apparatus 10, the controller 31 transitions the image forming apparatus 10 to the fourth power-consumption mode in which power consumption is smaller than in the third power-consumption mode.

The fourth power-consumption mode is a mode in which power consumption is smaller than in the third power-consumption mode and may be a mode in which power consumption equals the power consumption, for example, in the second power-consumption mode or in the first power-consumption mode. It is assumed that the fourth power-consumption mode is the same as the first power-consumption mode in the present exemplary embodiment.

The point of transition from the power-saving mode to the normal operating mode and the point of transition from the normal operating mode to the power-saving mode can independently be set because of the implementation of these modes.

In the present exemplary embodiment, the controller 31 may render the detection of the observation target in the first detection area R1 or in the second detection area R2 for transitioning to the fourth power-consumption mode ineffective when the observation target is undetected in the first detection area R1 or when the image forming apparatus 10 is not in the third power-consumption mode. The phrase “render the detection of the observation target in the first detection area R1 or in the second detection area R2 for transitioning to the fourth power-consumption mode ineffective” means that the observation target is detected in the first detection area R1 or in the second detection area R2 but the procedure for transitioning to the fourth power-consumption mode in accordance with the result of the detection in the first detection area R1 or in the second detection area R2 is not performed.

Further, the controller 31 may be configured to individually recognize observation targets that have been observed and refrain from transitioning the image forming apparatus 10 to the fourth power-consumption mode while an observation target other than a specific observation target that has been recognized is present in the first detection area R1 even when the controller 31 detects that the specific observation target moves from the second detection area R2 to the third detection area R3.

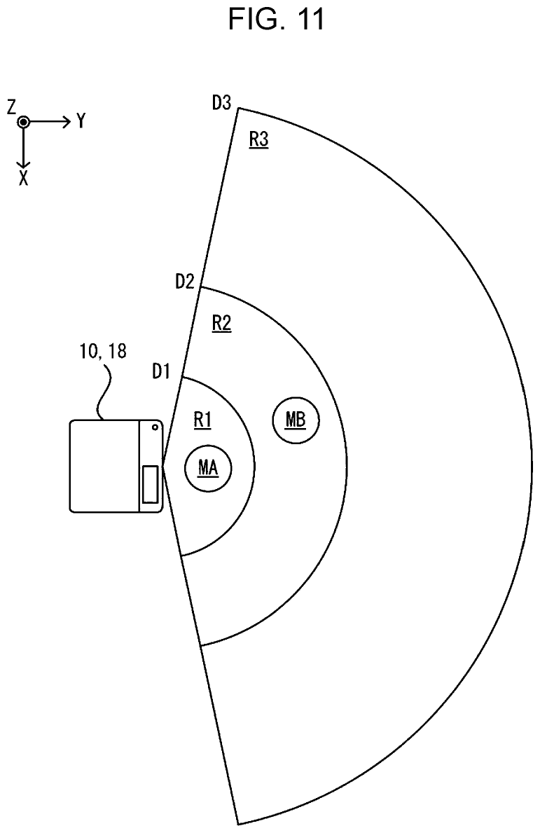

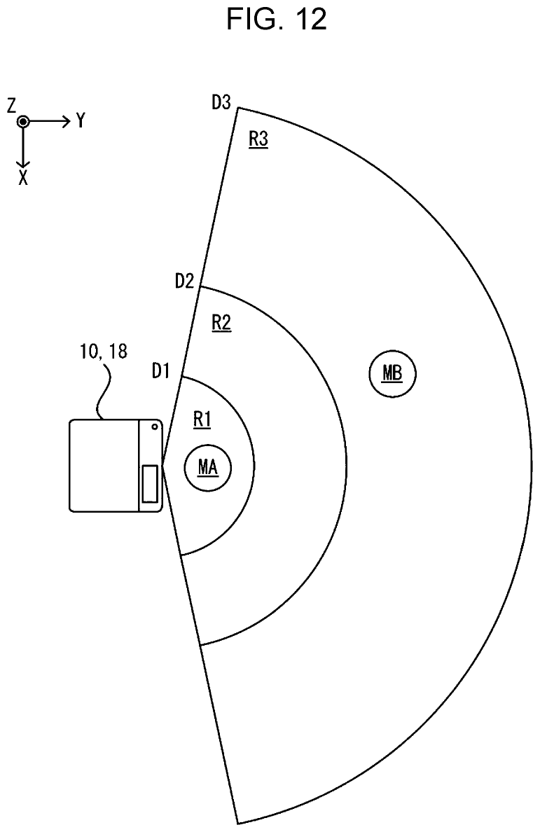

A detailed description will be given with regard to this procedure. FIG. 11 is a drawing depicting a situation in which two observation targets are present in the detection area of the human detector 18 and the two observation targets are located one each in the first detection area R1 and the second detection area R2. FIG. 12 is a drawing depicting a situation in which two observation targets are present in the detection area of the human detector 18 and one of the two observation targets is located outside the second detection area R2.

As depicted in FIG. 11 as an example, when two observation targets MA and MB are present in the detection area of the human detector 18, the controller 31 individually recognizes the two observation targets MA and MB.

Any method for individually recognizing multiple observation targets may be adopted, and, for example, the positions of observation targets may individually be recognized by attaching a unique ID to each detected signal in a graph representing the condition of signals detected by an ultrasonic sensor and tracing the movement of each signal having the same ID.

The controller 31 is configured to refrain from transitioning the image forming apparatus 10 to the fourth power-consumption mode while the other observation target MB is present in the first detection area R1 or in the second detection area R2 even when the controller 31 detects that the observation target MA moves from the second detection area R2, as depicted in FIG. 11, to the third detection area R3, as depicted in FIG. 12.

In addition, the controller 31 may be configured to change the size of the second detection area R2 in accordance with the detail of the operation performed on the image forming apparatus 10 while the image forming apparatus 10 is in the third power-consumption mode.

In this case, the controller 31 may be configured to set the size of the second detection area R2 to a larger value when an operation of outputting a sheet from the image forming apparatus 10 has been performed than when an operation other than the operation of outputting a sheet from the image forming apparatus 10 has been performed.

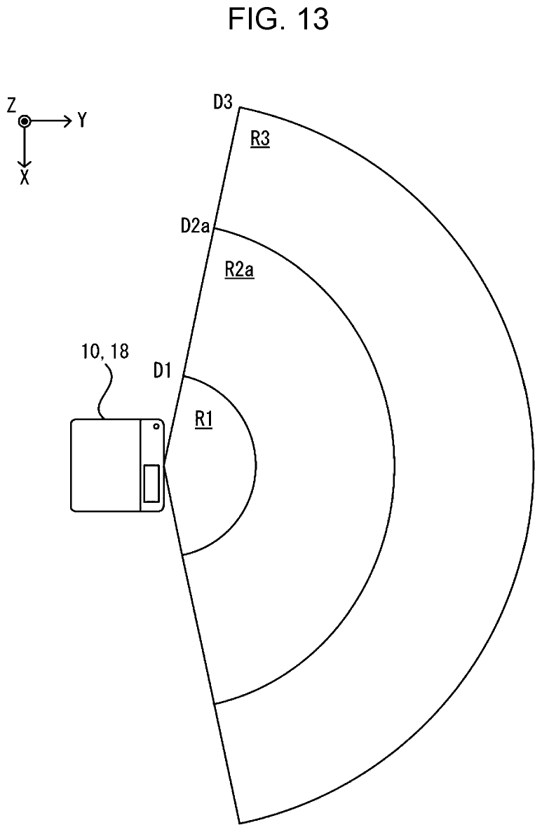

A detailed description will be given with regard to this procedure. It is assumed that the size of the second detection area R2 that is set when an operation other than the operation of outputting a sheet, such as a facsimile transmission or email transmission job, has been performed, is the size depicted in FIG. 4. When an operation of outputting a sheet, such as a copying or printing job, has been performed, the controller 31 sets the size of the second detection area R2a to a larger value than the size of the second detection area R2, which is set when an operation other than the operation of outputting a sheet has been performed, as depicted in FIG. 13.

The controller 31 may also be configured to, after the size of the second detection area R2 is changed and the operation performed on the image forming apparatus 10 is finished, reset the size of the second detection area R2 to a value before the change in the size of the second detection area R2.

The controller 31 may also be configured to identify as a detection target an observation target detected at the position closest to the human detector 18 when multiple observation targets are detected. For example, as depicted in FIG. 11, when two observation targets MA and MB are detected, the observation target MA, which is detected at the position closest to the human detector 18, is identified as the detection target and it may be assumed that the other observation target MB is not detected.

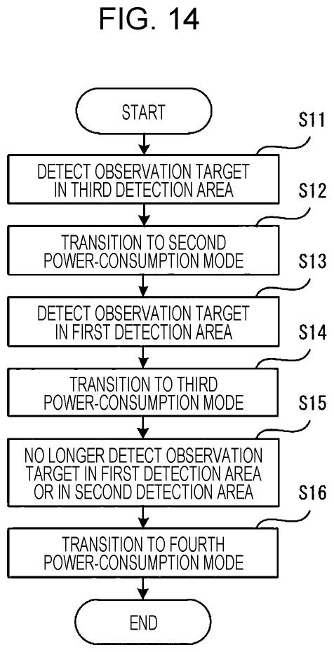

Next, referring to the flowchart in FIG. 14, a description will be given with regard to a process for controlling the power-consumption mode performed by the image forming apparatus 10 according to the present exemplary embodiment.

When no observation target M is present in the detection area of the human detector 18, the controller 31 sets the power-consumption mode of the image forming apparatus 10 to the first power-consumption mode in which power consumption is minimum.

In this situation, when the controller 31 detects an observation target in the third detection area R3 in step S11, the controller 31 transitions the image forming apparatus 10 to the second power-consumption mode in step S12, in which power consumption is larger than in the first power-consumption mode.

Next, when the controller 31 detects an observation target in the first detection area R1 in step S13, the controller 31 transitions the image forming apparatus 10 to the third power-consumption mode in step S14, in which power consumption is larger than in the second power-consumption mode.

Thereafter, when the controller 31 no longer detects an observation target in the first detection area R1 or in the second detection area R2 in step S15, the controller 31 transitions the image forming apparatus 10 to the fourth power-consumption mode in step S16, in which power consumption is smaller than in the third power-consumption mode.

### Modification

Although the detection area of the human detector 18 is divided into three areas, that is, the first detection area R1, the second detection area R2, and the third detection area R3 in the above exemplary embodiment, this is not meant to be limiting, and the detection area may be divided into two detection areas.

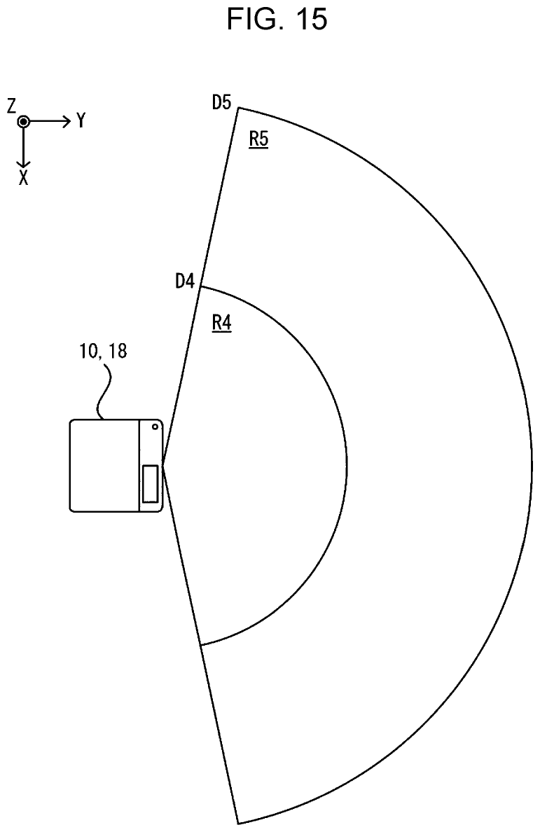

Specifically, as depicted in FIG. 15, the detection area of the human detector 18 may include the fourth detection area R4 and the fifth detection area R5 that includes the fourth detection area R4 and a region located farther from the human detector 18 than the fourth detection area R4 is, and the controller 31 may be configured to transition the image forming apparatus 10 from a first power-consumption mode to a second power-consumption mode when an observation target is detected in the fifth detection area R5, power consumption being larger in the second power-consumption mode than in the first power-consumption mode, and transition the image forming apparatus 10 to a third power-consumption mode when the observation target is no longer detected in the fourth detection area R4 after the image forming apparatus 10 enters the second power-consumption mode and the observation target is detected in the fourth detection area R4, power consumption being smaller in the third power-consumption mode than in the second power-consumption mode.

In the above exemplary embodiment, the description has been given with regard to the examples in which the present disclosure is applied to the image forming apparatus 10, but these examples are presented by way of illustration and not by way of limitation. For example, the present disclosure may similarly be applied to an information processing apparatus such as an automatic teller machine (ATM) or a ticket dispenser, which is approached by a user who performs operation, or to an apparatus such as a self-driving automated guided vehicle or a robot cleaner, which is configured to detect an obstacle.

Although the power-consumption mode is controlled only based on the detection result obtained by the human detector 18, the power-consumption mode may be controlled by using the human detector 18 and based on the entry into the touch panel. Specifically, an entry into the touch panel may restore the normal operating mode.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An electronic apparatus comprising:
a human detector configured to detect presence of an observation target; and
a processor,
wherein a detection area of the human detector includes a first detection area, a second detection area located farther from the human detector than the first detection area is, and a third detection area that includes the second detection area and a region located farther from the human detector than the second detection area is, and
wherein the processor is configured to:
   transition the electronic apparatus from a first power-consumption mode to a second power-consumption mode when an observation target is detected in the third detection area, power consumption being larger in the second power-consumption mode than in the first power-consumption mode,
   transition the electronic apparatus to a third power-consumption mode when the observation target is detected in the first detection area, the power consumption being larger in the third power-consumption mode than in the second power-consumption mode, and
   transition the electronic apparatus to a fourth power-consumption mode when the observation target is no longer detected in the first detection area or in the second detection area after the electronic apparatus enters the third power-consumption mode, the power consumption being smaller in the fourth power-consumption mode than in the third power-consumption mode.
(((2)))

The electronic apparatus according to (((1))),
wherein the processor is configured to:
   render detection of the observation target in the first detection area or in the second detection area for transitioning to the fourth power-consumption mode ineffective when the observation target is undetected in the first detection area or when the electronic apparatus is not in the third power-consumption mode.
(((3)))

The electronic apparatus according to (((1))) or (((2))),
wherein power consumption in the fourth power-consumption mode is the same as power consumption in the first power-consumption mode.
(((4)))

The electronic apparatus according to any one of (((1))) to (((3))),
wherein the processor is configured to:
   individually recognize observation targets that have been observed, and
   refrain from transitioning the electronic apparatus to the fourth power-consumption mode while an observation target other than a specific observation target that has been recognized is present in the first detection area or in the second detection area even when the processor detects that the specific observation target moves from the second detection area to the third detection area.
(((5)))

The electronic apparatus according to any one of (((1))) to (((4))),
wherein the processor is configured to:
   change a size of the second detection area in accordance with a detail of an operation performed on the electronic apparatus while the electronic apparatus is in the third power-consumption mode.
(((6)))

The electronic apparatus according to (((5))),
wherein the processor is configured to:
   set the size of the second detection area to a larger value when an operation of outputting a sheet from the electronic apparatus has been performed than when an operation other than the operation of outputting a sheet from the electronic apparatus has been performed.
(((7)))

The electronic apparatus according to (((5))) or (((6))),
wherein the processor is configured to:
   after the size of the second detection area is changed and the operation performed on the electronic apparatus is finished, reset the size of the second detection area to a value before the change in the size of the second detection area.
(((8)))

The electronic apparatus according to any one of (((1))) to (((7))),
wherein the human detector is a sonic sensor.
(((9)))

The electronic apparatus according to any one of (((1))) to (((8))),
wherein the processor is configured to:
   identify as a detection target an observation target detected at a position closest to the human detector when a plurality of observation targets are detected.
(((10)))

An electronic apparatus comprising:
a human detector configured to detect presence of an observation target; and
a processor,
wherein a detection area of the human detector includes a fourth detection area and a fifth detection area that includes the fourth detection area and a region located farther from the human detector than the fourth detection area is, and
wherein the processor is configured to:
   transition the electronic apparatus from a first power-consumption mode to a second power-consumption mode when an observation target is detected in the fifth detection area, power consumption being larger in the second power-consumption mode than in the first power-consumption mode, and
   transition the electronic apparatus to a third power-consumption mode when the observation target is no longer detected in the fourth detection area after the electronic apparatus enters the second power-consumption mode and the observation target is detected in the fourth detection area, the power consumption being smaller in the third power-consumption mode than in the second power-consumption mode.
(((11)))

A program causing a computer to execute a process, the computer being included in an electronic apparatus equipped with a human detector configured to detect presence of an observation target, the process comprising:
acquiring a signal detected by the human detector, the human detector having a first detection area, a second detection area located farther from the human detector than the first detection area is, and a third detection area that includes the second detection area and a region located farther from the human detector than the second detection area is;
transitioning the electronic apparatus from a first power-consumption mode to a second power-consumption mode when an observation target is detected in the third detection area, power consumption being larger in the second power-consumption mode than in the first power-consumption mode;
transitioning the electronic apparatus to a third power-consumption mode when the observation target is detected in the first detection area, the power consumption being larger in the third power-consumption mode than in the second power-consumption mode; and
transitioning the electronic apparatus to a fourth power-consumption mode when the observation target is no longer detected in the first detection area or in the second detection area after the electronic apparatus enters the third power-consumption mode, the power consumption being smaller in the fourth power-consumption mode than in the third power-consumption mode.
(((12)))

A program causing a computer to execute a process, the computer being included in an electronic apparatus equipped with a human detector configured to detect presence of an observation target, the process comprising:
acquiring a signal detected by the human detector, the human detector having a fourth detection area and a fifth detection area that includes the fourth detection area and a region located farther from the human detector than the fourth detection area is;
transitioning the electronic apparatus from a first power-consumption mode to a second power-consumption mode when an observation target is detected in the fifth detection area, power consumption being larger in the second power-consumption mode than in the first power-consumption mode; and
transitioning the electronic apparatus to a third power-consumption mode when the observation target is no longer detected in the fourth detection area after the electronic apparatus enters the second power-consumption mode and the observation target is detected in the fourth detection area, the power consumption being smaller in the third power-consumption mode than in the second power-consumption mode.

What is claimed is:

1. An electronic apparatus comprising:
a human detector configured to detect presence of an observation target; and
a processor,
wherein a detection area of the human detector includes a first detection area, a second detection area located farther from the human detector than the first detection area is, and a third detection area that includes the second detection area and a region located farther from the human detector than the second detection area is, and
wherein the processor is configured to:
transition the electronic apparatus from a first power-consumption mode to a second power-consumption mode when an observation target is detected in the third detection area, power consumption being larger in the second power-consumption mode than in the first power-consumption mode,
transition the electronic apparatus to a third power-consumption mode when the observation target is detected in the first detection area, the power consumption being larger in the third power-consumption mode than in the second power-consumption mode, and
transition the electronic apparatus to a fourth power-consumption mode when the observation target is no longer detected in the first detection area or in the second detection area after the electronic apparatus enters the third power-consumption mode, the power consumption being smaller in the fourth power-consumption mode than in the third power-consumption mode.

2. The electronic apparatus according to claim 1,
wherein the processor is configured to:
render detection of the observation target in the first detection area or in the second detection area for transitioning to the fourth power-consumption mode ineffective when the observation target is undetected in the first detection area or when the electronic apparatus is not in the third power-consumption mode.

3. The electronic apparatus according to claim 1,
wherein power consumption in the fourth power-consumption mode is the same as power consumption in the first power-consumption mode.

4. The electronic apparatus according to claim 1,
wherein the processor is configured to:
individually recognize observation targets that have been observed, and
refrain from transitioning the electronic apparatus to the fourth power-consumption mode while an observation target other than a specific observation target that has been recognized is present in the first detection area or in the second detection area even when the processor detects that the specific observation target moves from the second detection area to the third detection area.

5. The electronic apparatus according to claim 1,
wherein the processor is configured to:
change a size of the second detection area in accordance with a detail of an operation performed on the electronic apparatus while the electronic apparatus is in the third power-consumption mode.

6. The electronic apparatus according to claim 5,
wherein the processor is configured to:
set the size of the second detection area to a larger value when an operation of outputting a sheet from the electronic apparatus has been performed than when an operation other than the operation of outputting a sheet from the electronic apparatus has been performed.

7. The electronic apparatus according to claim 5,
wherein the processor is configured to:
after the size of the second detection area is changed and the operation performed on the electronic apparatus is finished, reset the size of the second detection area to a value before the change in the size of the second detection area.

8. The electronic apparatus according to claim 1,
wherein the human detector is a sonic sensor.

9. The electronic apparatus according to claim 1,
wherein the processor is configured to:
identify as a detection target an observation target detected at a position closest to the human detector when a plurality of observation targets are detected.

10. An electronic apparatus comprising:
a human detector configured to detect presence of an observation target; and
a processor,
wherein a detection area of the human detector includes a fourth detection area and a fifth detection area that includes the fourth detection area and a region located farther from the human detector than the fourth detection area is, and
wherein the processor is configured to:
transition the electronic apparatus from a first power-consumption mode to a second power-consumption mode when an observation target is detected in the fifth detection area, power consumption being larger in the second power-consumption mode than in the first power-consumption mode, and
transition the electronic apparatus to a third power-consumption mode when the observation target is no longer detected in the fourth detection area after the electronic apparatus enters the second power-consumption mode and the observation target is detected in the fourth detection area, the power consumption being smaller in the third power-consumption mode than in the second power-consumption mode.

11. A non-transitory computer readable medium storing a program causing a computer to execute a process, the computer being included in an electronic apparatus equipped with a human detector configured to detect presence of an observation target, the process comprising:
acquiring a signal detected by the human detector, the human detector having a first detection area, a second detection area located farther from the human detector than the first detection area is, and a third detection area that includes the second detection area and a region located farther from the human detector than the second detection area is;
transitioning the electronic apparatus from a first power-consumption mode to a second power-consumption mode when an observation target is detected in the third detection area, power consumption being larger in the second power-consumption mode than in the first power-consumption mode;
transitioning the electronic apparatus to a third power-consumption mode when the observation target is detected in the first detection area, the power consumption being larger in the third power-consumption mode than in the second power-consumption mode; and
transitioning the electronic apparatus to a fourth power-consumption mode when the observation target is no longer detected in the first detection area or in the second detection area after the electronic apparatus enters the third power-consumption mode, the power consumption being smaller in the fourth power-consumption mode than in the third power-consumption mode.
